(19) United States
(12) Patent Application Publication
(10) Pub. No.: US 2010/0072321 A1
(43) Pub. Date: Mar. 25, 2010

(54) SYSTEM AND METHOD FOR OPERATING A HYBRID LAUNCH SYSTEM

(75) Inventor: Roger Xavier Lenard, Edgewood, NM (US)

Correspondence Address: DOCKET CLERK, P.O. DRAWER 800889, DALLAS, TX, 75380, US

(73) Assignee: Heliosat, Inc., Dallas, TX (US)

(21) Appl. No.: 12/566,595

(22) Filed: Sep. 24, 2009

Related U.S. Application Data
(60) Provisional application No. 61/099,837, filed on Sep. 24, 2008.

(51) Int. Cl. B64G 1/00

(52) U.S. Cl. 244/158.2

(57) ABSTRACT

A system includes a gravity gradient stabilized space tether. The gravity gradient stabilized space tether includes a tether body having an upper end and a lower end. The gravity gradient stabilized space tether also includes an upper base station located at the upper end of the tether body and a lower base station located at the lower end of the tether body. The gravity gradient stabilized space tether further includes a device coupled to the lower base station. The device can be lowered to a distance below the lower base station to a rendezvous point that is proximate to an orbital path of a sub-orbital vehicle.

### CROSS-REFERENCE TO RELATED APPLICATION(S) AND CLAIM OF PRIORITY

The present application is related to U.S. Provisional Patent No. 61/099,837, filed Sep. 24, 2008, entitled “SYSTEM AND METHOD FOR OPERATING A SPACE TETHER”. The present application hereby claims priority under 35 U.S.C. §119(e) to U.S. Provisional Patent No. 61/099,837, which is incorporated herein by reference.

### TECHNICAL FIELD OF THE INVENTION

The present invention relates generally to orbiting satellite technology.

### BACKGROUND OF THE INVENTION

The affordability, reliability and timeliness of access to space have been major problems since the dawn of the space age. The rocket power that is necessary to lift large payloads into orbit is quite expensive. Relatively small low-cost rockets can efficiently lift small payloads of approximately fifty pounds (50 lb.). Small low-cost rockets, however, do not carry sufficient fuel or have sufficient power to achieve orbit. Rocket vehicles that are not able to achieve orbit are referred to as sub-orbital rocket vehicles.

FIG. 1 illustrates a system to receive a cargo from a sub-orbital rocket vehicle and transfer the cargo into earth orbit. A sub-orbital cargo-carrying vehicle 110 is launched from the surface of the earth 100. A rotating tether transport facility 120 is provided in earth orbit. The rotating tether transport facility 120 can rendezvous with the sub-orbital cargo-carrying vehicle 110 at a pre-selected time and space. The rotating tether transport facility 120 orbits at an altitude of approximately four hundred kilometers (400 km). The rotating tether transport facility 120 comprises a tether 130 that can be, for example, approximately three hundred kilometers (300 km) long.

As shown in FIG. 1, as the rotating tether transport facility 120 rotates into position at the rendezvous point, the tether 130 captures a payload from the sub-orbital cargo-carrying vehicle 110 at an altitude of, for example, approximately one hundred kilometers (100 km).

The rotating tether transport facility 120 continues to rotate with the payload attached to the end of the tether 130. The payload is subsequently released after one half on a revolution (as shown by the curved arrow 140 in FIG. 1). This boosts the velocity of the payload and launches the payload into space (or into earth orbit depending on the velocity of the payload).

Using the rotating tether transport facility 120 has significant disadvantages. The rotational speed of the facility 120 is high with respect to the orbital speed. That is, the rotating tether transport facility 130 rotates rapidly.

The rotating tether transport facility 120 also is a significant space navigation threat. The tether 130 can be approximately three hundred kilometers (300 km) long. The tether 130 is continually rotating through space through which satellites and space stations orbit. There is a risk that the tether 130 will collide with orbiting satellites and space stations.

Further, when using the rotating tether transport facility 120 and tether 130, the timing of the rendezvous with a sub-orbital cargo-carrying vehicle is very critical. The rendezvous must be exact down to a timing window of several seconds. It is often very difficult to capture the payload with the tether 130.

### SUMMARY OF THE INVENTION

To address the above-discussed deficiencies of the prior art, the present disclosure provides a system and method for a space tether.

An space cargo handling system is provided. The space cargo handling system includes a gravity gradient stabilized space tether having an upper end and a lower end. The space cargo handling system further includes a device connected to the lower end of the tether, the device adapted to be lowered to a distance below the lower end of the tether. The tether is configured to maintain a vertical orientation with respect a planetary body when in orbit about the planetary body.

An gravity gradient stabilized space tether is provided. The gravity gradient stabilized space tether includes a tether body having an upper end and a lower end. The gravity gradient stabilized space tether also includes an upper base station located at the upper end of the tether body and a lower base station located at the lower end of the tether body. The gravity gradient stabilized space tether further includes a device coupled to the lower base station. The device can be lowered to a distance below the lower base station to a rendezvous point that is proximate to an orbital path of a sub-orbital vehicle.

A method for operating a space tether is provided. The method for operating a space tether includes lowering a device from a lower end of a gravity gradient stabilized tether. The gravity gradient stabilized tether includes an upper end and the lower end. The device is lowered to a rendezvous point at a distance below the lower end of the tether. The method also includes making a rendezvous with a sub-orbital cargo-carrying vehicle at the rendezvous point; and attaching the device to a cargo from the vehicle. The method further includes retracting the device and the cargo to the lower end of the tether.

The foregoing has outlined rather broadly the features and technical advantages of the present invention so that those skilled in the art may better understand the detailed description of the invention that follows. Additional features and advantages of the invention will be described hereinafter that form the subject of the claims of the invention. Those skilled in the art should appreciate that they may readily use the conception and the specific embodiment disclosed as a basis for modifying or designing other structures for carrying out the same purposes of the present invention. Those skilled in the art should also realize that such equivalent constructions do not depart from the spirit and scope of the invention in its broadest form.

Before undertaking the DETAILED DESCRIPTION OF THE INVENTION below, it may be advantageous to set forth definitions of certain words and phrases used throughout this patent document: the terms “include” and “comprise,” as well as derivatives thereof, mean inclusion without limitation; the term “or,” is inclusive, meaning and/or; “each” means every one of at least a subset of the identified items; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like. Definitions for certain words and phrases are provided throughout this patent document, those of ordinary skill in the art should understand that in many, if not most instances, such definitions apply to prior, as well as future, uses of such defined words and phrases.

### BRIEF DESCRIPTION OF THE DRAWINGS

For a more complete understanding of the present invention and its advantages, reference is now made to the following description taken in conjunction with the accompanying drawings, wherein like reference numerals represent like parts, in which:

FIG. 1 illustrates a diagram for a rotating space tether in earth orbit;

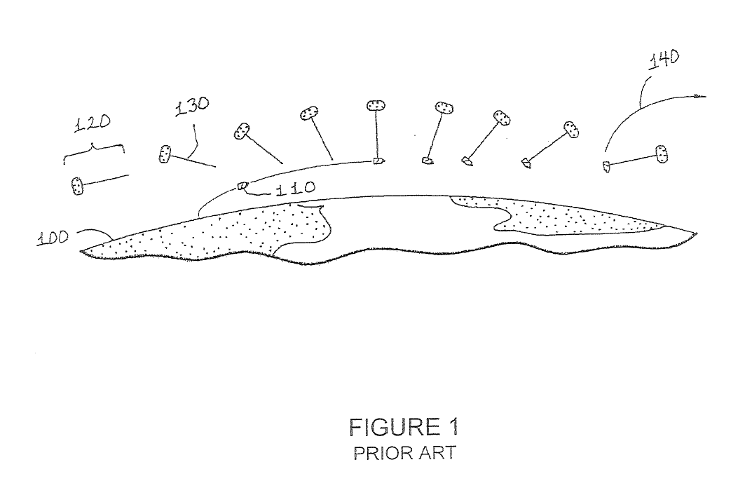

FIG. 2 illustrates a diagram for a gravity gradient stabilized tether according to embodiments of the present disclosure;

FIG. 3 illustrates a diagram for an operation of a cable that is temporarily extended from the end of the gravity gradient stabilized tether according to embodiments of the present disclosure;

FIG. 4 illustrates a diagram for an operation to move a cargo from the lower end of the tether to the upper end of the tether according to embodiments of the present disclosure;

FIG. 5 illustrates a diagram for an operation to launch one or more items of cargo from the top end of the tether in a desired direction according to embodiments of the present disclosure; and

FIG. 6 illustrates a flow chart for a method for operating a space tether according to embodiments of the present disclosure.

### DETAILED DESCRIPTION OF THE INVENTION

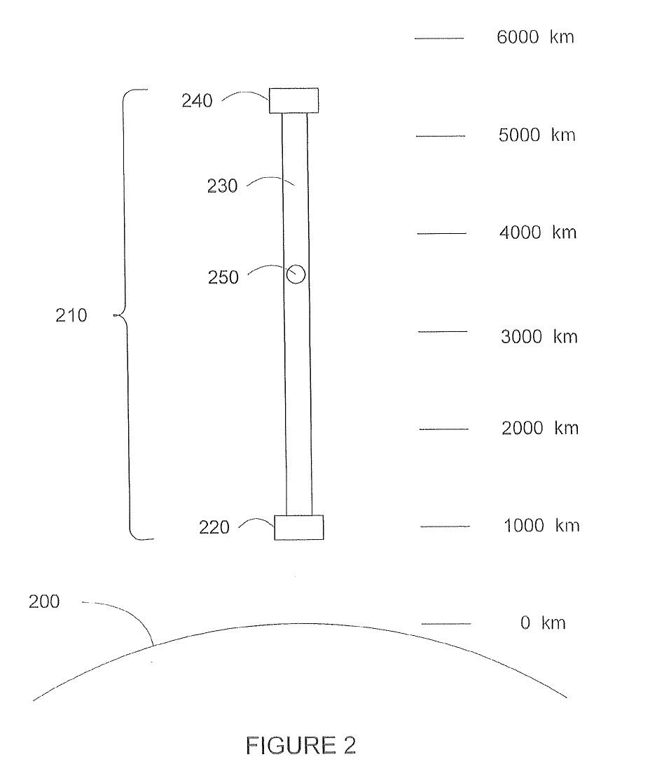

FIGS. 2 through 6 and the various embodiments used to describe the principles of the present invention in this patent document are by way of illustration only and should not be construed in any way to limit the scope of the invention. Those skilled in the art will understand that the principles of the present invention may be implemented in any type of suitably arranged space tether system.

FIG. 2 illustrates a diagram for a gravity gradient stabilized tether according to embodiments of the present disclosure. The embodiment of the gravity gradient stabilized tether 210 shown in FIG. 2 is for illustration only. Other embodiments could be used without departing from the scope of this disclosure.

A gravity gradient stabilized tether 210 can be placed into orbit around the earth 200. In some embodiments the tether 210 can be placed into earth around some other planetary body or natural satellite, such as, for example, a moon. The rotational speed of some rotating tethers can be high when compared with the orbital period of the tether. However, the tether 210 can be configured to make exactly one rotation per orbital period.

The tether 210 can be configured to perform only one rotation per orbital period such that the length of the tether 210 can be maintain an orientation in a vertical direction (i.e., radial direction) with respect to the surface of the earth 200. The tether includes a gravity gradient stabilization which means that the length of the tether 210 will substantially always point toward the surface of the earth 200

The tether 210 includes a lower base station 220 at the lower end of the tether 210, a tether body 230, and an upper base station 240 at the upper end of the tether 210. As shown in FIG. 2, the tether 210 is placed in orbit above the earth 200 and positioned so that the lower base station 220 is located, for example, approximately one thousand kilometers (1000 km) above the surface of the earth 200. It will be understood that the tether 210 is not drawn to scale in FIG. 2. Further, the radius of the earth 200 is about six thousand three hundred seventy eight kilometers (6378 km).

In one embodiment, the length of the tether 210 is approximately four thousand three hundred kilometers (4300 km). Therefore, in this example, the upper base station 240 is located above the earth 200 at a height of approximately five thousand three hundred kilometers (5300 km). This height is below most operational orbits.

The orbital speed of the upper end of the tether 210 is faster than the orbital speed of the lower end of the tether 210. For example, an orbital speed for the center of mass 250 of the tether 210 can be approximately six and two tenths kilometers per second (6.2 km/sec) and an altitude for the center of mass 250 of the tether 210 can be approximately three thousand six hundred kilometers (3600 km).

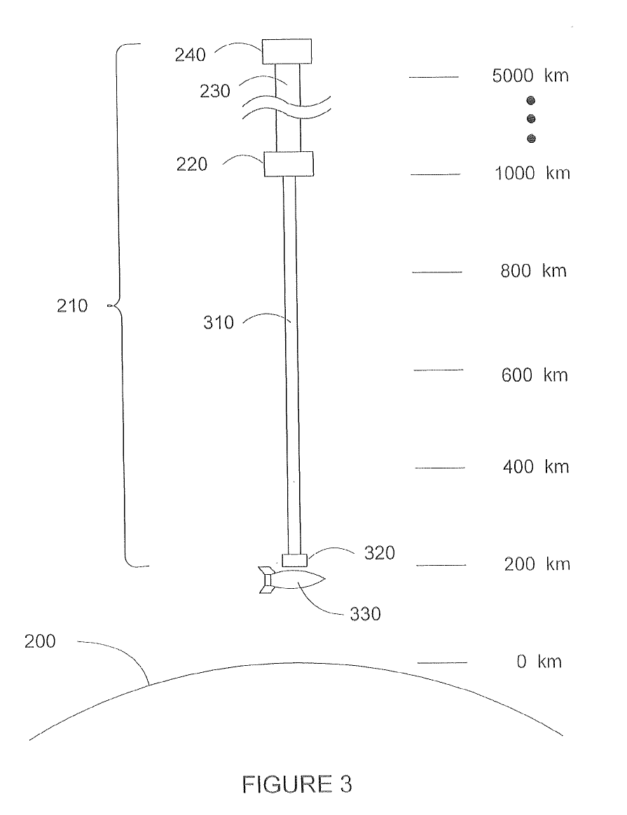

FIG. 3 illustrates a diagram for an operation of a cable 310 that is temporarily extended from the lower base station 220 of the tether 210 to a sub-orbital cargo carrying vehicle 330. The embodiment of the operation shown in FIG. 3 is for illustration only. Other embodiments could be used without departing from the scope of this disclosure.

In the example shown in FIG. 3, the portion of the tether 210 (illustrated in FIG. 2) from the lower base station 220 to the upper base station 240 is shown between the one thousand kilometer (1000 km) height and the five thousand three hundred kilometer (5300 km) height respectively. It will be understood that the tether 210 is not illustrated to scale in FIG. 3 and that the three black dots between the scale markers for the one thousand kilometer (1000 km) height and the five thousand kilometer (5000 km) height signify that a different scale is being used for that portion of the drawing.

The tether 210 includes a cable 310. The cable 310 can be extended from the lower base station 220 in a direction substantially towards the earth 200. The cable 310 can be dimensioned such that, when extended from the lower base station 220, the cable can extend to approximately eight hundred kilometers (800 km) towards the earth 200 from the lower base station 220. For example, the cable 310 can be extended from the lower base station 200, which is at a height of one thousand kilometers (1000 km) above the earth 200, down to a height of approximately two hundred kilometers (200 km) above the earth 200. It will be understood that the cable 310 is not drawn to scale in FIG. 3 and that the illustration of the cable 310 dimensioned to extend to approximately eight hundred kilometers (800 km) is for example purposes and many other dimensions are possible. When the lower end of the cable 310 is extended down to a height of approximately two hundred kilometers (200 km) above the earth 200, then the orbital speed of the lower end of the cable 310 is approximately four and two tenths kilometers per second (4.2 km/sec).

The tether 210 includes a cargo attachment device 320 affixed to the lower end of the cable 310. In some embodiments, the cargo attachment device 320 comprises a crane hook device (not shown) that is capable of hooking onto a cargo container. The cargo attachment device 320 may comprise any appropriate type of device that is capable of being securely attached to a cargo container.

For example, a sub-orbital cargo carrying vehicle 330 may be orbiting the earth 200. The sub-orbital cargo-carrying vehicle 330 may have been previously launched from the surface of the earth 200. The sub-orbital cargo-carrying vehicle 330 can be a re-usable sub-orbital cargo-carrying vehicle. The sub-orbital cargo carrying vehicle 330 can meet and align with the cargo attachment device 320 at a rendezvous point. The rendezvous point can correspond to a position of the cargo attachment device 320 after the cable 310 has been fully extended down to the two hundred kilometer (200 km) height. Additionally, the rendezvous point can correspond to a position of the cargo attachment device 320 when the cable 310 has been incrementally extended (i.e., has not been fully extended). The sub-orbital cargo carrying vehicle 330 can perform the rendezvous by matching the orbital speed of the cargo attachment device 320 at the height (e.g., elevation) of the cargo attachment device 320. In one embodiment, the orbital speed is approximately four and two tenths kilometers per second (4.2 km/sec) and the height of the cargo attachment device 320 is two hundred kilometer (200 km) above the earth 200.

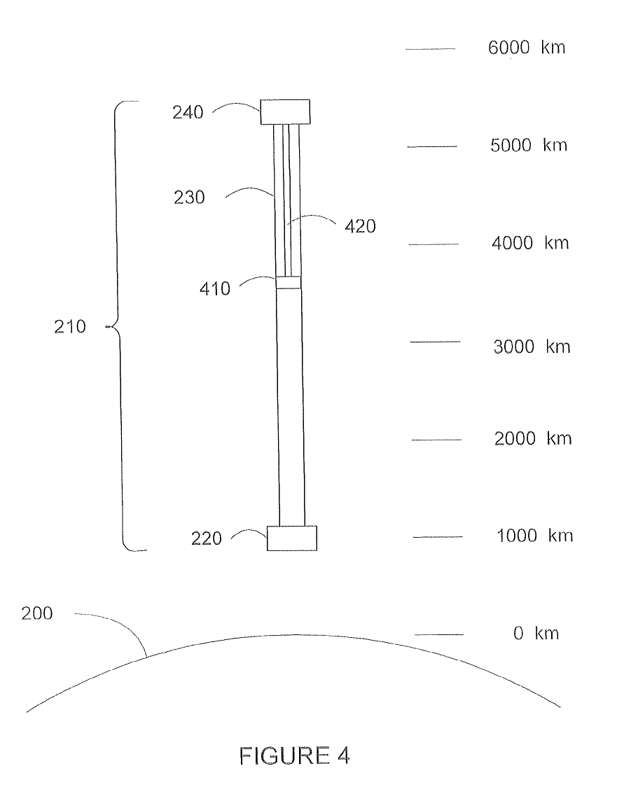

After the vehicle 330 has established a position proximate to the cargo attachment device 320, the cargo attachment device 320 can attach to the cargo payload from the vehicle 330. For example, when the vehicle 330 is in an orbit adjacent to the cargo attachment device 320, which is at the end of the cable 310, the cargo attachment device 320 attaches to the cargo payload from the vehicle 330. After the cargo is secured by the cargo attachment device 320, the cable 310 can be retracted to the lower base station 220. After the cable 310 has been retracted and the cargo pulled-up to the lower base station 220, the cargo then can be transferred to and secured within a cargo lift device 410 (discussed in more detail herein below with respect to FIG. 4). Additionally, the cable 310 then can be stored within the lower base station 220 until the next time that the cable 310 is used.

FIG. 4 illustrates a diagram for an operation to move a cargo from the lower end of the tether to the upper end of the tether according to embodiments of the present disclosure. The embodiment of the cargo movement operation shown in FIG. 4 is for illustration only. Other embodiments could be used without departing from the scope of this disclosure.

The tether 210 includes a cargo lift device 410. The cargo lift device 410 is configured to move cargo from the lower base station 220 to the upper base station 240. The cargo lift device 410 traverses a path along the tether body 230. The cargo lift device 410 can be a part of an elevator system, rail system, operator driven vehicle, or some other system adapted to move cargo. The cargo, in the cargo lift device 410, then can be moved from the lower base station 220 at the lower end of the tether 210 to the upper base station 240 at the upper end of the tether 210. The tether 210 is not drawn to scale in FIG. 4.

In some embodiments, a tether climber device 420 is attached to the cargo lift device 410. The tether climber device 420 is configured to pull the cargo lift device 410 towards the upper base station. Accordingly, when the cargo lift device 410 includes cargo, the tether climber device 410 can pull the cargo lift device 410 and the cargo up to the upper base station 340. In one embodiment, the tether climber device 420 may comprise a cable or similar structure.

After the cargo lift device 410 has reached the upper base station 240, the cargo can be removed from the cargo lift device 410. For example, when the tether climber 410 has pulled the cargo lift device 410 up to the upper base station 240, an operator or other cargo moving apparatus can release (unsecure) and remove the cargo from the cargo lift device 410.

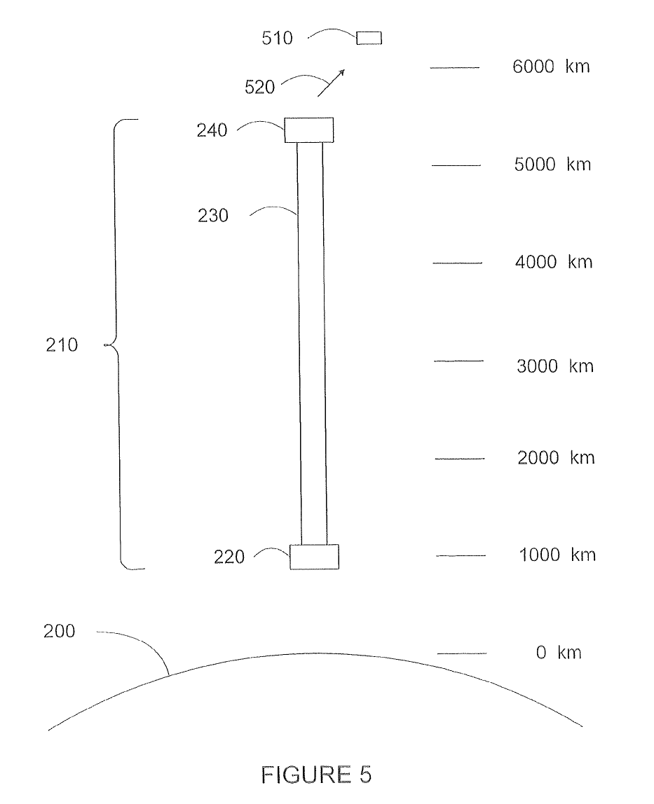

FIG. 5 illustrates a diagram for an operation to launch one or more items from the upper base station 240 according to embodiments of the present disclosure. The embodiment of the launching operation shown in FIG. 5 is for illustration only. Other embodiments could be used without departing from the scope of this disclosure.

Once the cargo has been removed from the cargo lift device 410, the cargo can be stored in the upper base station 240. Additionally and alternatively, the cargo (and, optionally, one or more previously delivered items of cargo) may then be launched from the upper base station 240 into space in a desired direction. The tether 210 is not drawn to scale in FIG. 5.

As shown in FIG. 5, the cargo 510 can be launched from the upper base station 240 at a height of approximately five thousand three hundred kilometers (5300 km). The cargo can be launched in a desired direction 520 based on orientation to the earth 200, a desired destination, or some other criteria.

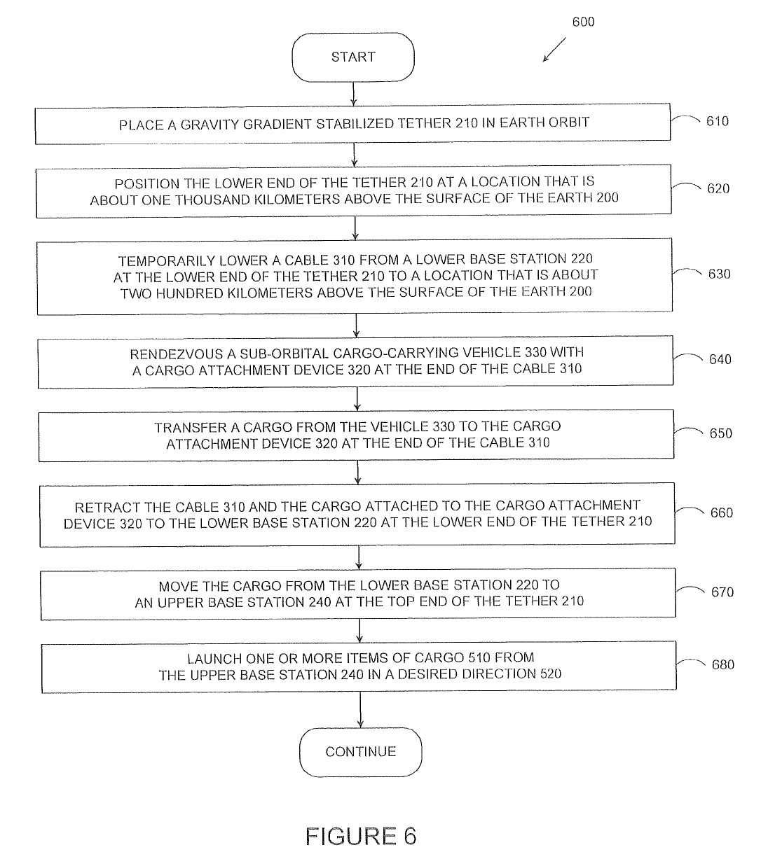

FIG. 6 illustrates a flow chart for a method for operating a space tether according to embodiments of the present disclosure. The embodiment of the method 600 shown in FIG. 6 is for illustration only. Other embodiments could be used without departing from the scope of this disclosure.

A gravity gradient stabilized tether 210 is placed in earth orbit (step 610). The lower end of the tether 210 is positioned at a location that is about one thousand kilometers (1000 km) above the surface of the earth 200 (step 620).

A cable 310 is temporarily extended downwardly from a lower base station 220 at the lower end of the tether 210 to a location that is about two hundred kilometers (200 km) above the surface of the earth 200 (step 630). A sub-orbital cargo-carrying vehicle 330 makes a rendezvous with a cargo attachment device 320 that is affixed to the end of the cable 310 (step 640).

A cargo is then transferred from the vehicle 330 and secured to the cargo attachment device 320 at the end of the cable 310. The cable 310 and the cargo attached to the cargo attachment device 320 are then retracted to the lower base station 320 at the lower end of the tether 210 (step 650). Then the cargo is moved from the lower base station 220 to an upper base station 240 at the top end of the tether 210 (step 660). Then the cargo 510 (and, optionally, one or more items of previously delivered cargo 510) are launched from the upper base station 240 in a desired direction 520 (step 680).

Using the system and method described above, the gravity gradient stabilized tether 210 is able to efficiently retrieve cargo from sub-orbital cargo-carrying vehicles. Because the lower base station 220 can be located at a height of about one thousand kilometers (1000 km), it is able to maintain a position above most of the orbits of Low Earth Orbit (LEO) satellites. Therefore, the tether 210 minimizes a space navigational threat to LEO satellite orbits.

Additionally, the cable is adapted to be temporarily lowered to a specified rendezvous point. When the cable 310 is lowered to the rendezvous point in order to retrieve cargo from a sub-orbital cargo-carrying vehicle 330, the cable only temporarily extends down below the one thousand kilometer (1000 km) height. As previously described, the cable 310 is retracted along with the cargo and does not remain in the region below the one thousand kilometer (1000 km) height.

As opposed to systems that use a rotating tether where the timing of the rendezvous with a sub-orbital cargo-carrying vehicle is very critical requiring a timing that is exact within a timing window of several seconds, the tether 210 and cable 310 disclosed herein do not require such precision. The timing of the rendezvous with the sub-orbital cargo-carrying vehicle 330 may be successfully carried out within a timing window of several minutes.

Although the present invention has been described with several embodiments, various changes and modifications may be suggested to one skilled in the art. It is intended that the present invention encompass such changes and modifications as fall within the scope of the appended claims.

What is claimed is:

1. A space cargo handling system comprising:
a gravity gradient stabilized space tether having an upper end and a lower end;
a device connected to the lower end of the tether, the device adapted to be lowered to a distance below the lower end of the tether, wherein the tether is configured to maintain a vertical orientation with respect a planetary body when in orbit about the planetary body; and
a sub-orbital vehicle configured to rendezvous with the tether such that a cargo can be transferred from the sub-orbital vehicle to the tether.

2. The system as set forth in claim 1 wherein the device is a cable.

3. The system as set forth in claim 1, wherein the tether is configured to lower the device to a rendezvous point that is proximate to the sub-orbital vehicle.

4. The system as set forth in claim 1 wherein the device that is connected to the lower end of the tether comprises a cargo attachment device adapted to attach to the cargo from the sub-orbital vehicle.

5. The system as set forth in claim 1, wherein the tether comprises:
a tether body between the upper end and the lower end;
an upper base station located at the upper end; and
a lower base station located at the lower end, wherein the device that is connected to the lower end of the tether is connected to the lower base station.

6. The system as set forth in claim 5, further comprising a cargo lift device configured to traverse a path along the tether body.

7. The system as set forth in claim 6 further comprising a tether climber coupled to the cargo lift device, the tether climber configured to lift the cargo life device from the lower base station to the upper base station.

8. The system as set forth in claim 1 wherein a distance from the upper end of the tether to the lower end of the tether is about four thousand three hundred kilometers.

9. The system as set forth in claim 1 wherein the device is dimensioned to extend to a distance up to eight hundred kilometers.

10. A gravity gradient stabilized space tether comprising:
a tether body having an upper end and a lower end;
an upper base station located at the upper end of the tether body;
a lower base station located at the lower end of the tether body; and
a device coupled to the lower base station, the device adapted to be lowered to a distance below the lower base station to a rendezvous point that is proximate to an orbital path of a sub-orbital vehicle.

11. The tether gravity gradient stabilized space tether as set forth in claim 10, wherein the device comprises a cargo attachment device adapted to attach to cargo from the sub-orbital vehicle.

12. The gravity gradient stabilized space tether as set forth in claim 10, wherein the tether is configured to perform one rotation per orbital period.

13. The gravity gradient stabilized space tether as set forth in claim 10, wherein the device comprises a cable.

14. The gravity gradient stabilized space tether as set forth in claim 10 wherein the cargo attachment device comprises a crane hook.

15. The gravity gradient stabilized space tether as set forth in claim 12 wherein a distance from the upper base station to the lower base station is about four thousand three hundred kilometers.

16. The gravity gradient stabilized space tether as set forth in claim 12 wherein the device is dimensioned to extend to a distance up to eight hundred kilometers.

17. A method for operating a space tether comprising the steps of:
lowering a device from a lower end of a gravity gradient stabilized tether, the gravity gradient stabilized tether having an upper end and the lower end, the device lowered to a rendezvous point at a distance below the lower end of the tether;
making a rendezvous with a sub-orbital cargo-carrying vehicle at the rendezvous point; and
attaching the device to a cargo from the vehicle; and
retracting the device and the cargo to the lower end of the tether.

18. The method as set forth in claim 17 further comprising moving the cargo from the lower end of the tether to the top end of the tether.

19. The method as set forth in claim 17 further comprising:
placing in an earth orbit the gravity gradient stabilized tether;
wherein a distance from the upper end of the tether to the lower end of the tether is about four thousand three hundred kilometers; and
wherein the lower end of the gravity gradient stabilized tether is placed within earth orbit at an altitude of about one thousand kilometers.

20. The method as set forth in claim 19 wherein the distance below the lower end of the tether to which the device can be lowered is about eight hundred kilometers.
